(19) United States
(12) Patent Application Publication
(10) Pub. No.: US 2024/0181990 A1
(43) Pub. Date: Jun. 6, 2024

(54) VEHICLE FRONT STRUCTURE

(71) Applicant: TOYOTA JIDOSHA KABUSHIKI KAISHA, Toyota-shi (JP)

(72) Inventor: Kousuke KUBO, Okazaki-shi (JP)

(73) Assignee: TOYOTA JIDOSHA KABUSHIKI KAISHA, Toyota-shi (JP)

(21) Appl. No.: 18/470,490

(22) Filed: Sep. 20, 2023

(30) Foreign Application Priority Data
Dec. 1, 2022 (JP) 2022-192573

(51) Int. Cl. B60S 1/34; B60J 1/02; B60S 1/38; B62D 25/08; B62D 25/10

(52) U.S. Cl. CPC B60S 1/3488; B60J 1/02; B60S 1/38; B62D 25/081; B62D 25/105

(57) ABSTRACT

The cowl top garnish includes an exposed surface and a rib. The exposed surface includes a front end having the same height as the rear end of the exposed surface of the engine hood, and extends in a planar shape from the front end to the windshield glass. The rib is provided in front of the wiper pivot, protrudes from the exposed surface of the cowl top garnish, and extends in the vehicle width direction along the blade.

### CROSS-REFERENCE TO RELATED APPLICATION

This application claims priority to Japanese Patent Application No. 2022-192573 filed on Dec. 1, 2022 incorporated herein by reference in its entirety.

### BACKGROUND

### 1. Technical Field

The present specification discloses a vehicle front structure.

### 2. Description of Related Art

A windshield glass is provided on a front surface of a vehicle cabin. An engine hood is provided in front of the windshield glass. A cowl top garnish is provided between the engine hood and the windshield glass.

Rainwater flows down from the windshield glass during rainy weather. This rainwater is received by the cowl top garnish. In other words, the cowl top garnish serves as a rain trough. Further, a wiper pivot that serves as a rotation axis of a wiper mechanism is attached to the cowl top garnish.

For example, a cowl top panel disclosed in Japanese Unexamined Patent Application Publication No. 2010-143288 (JP 2010-143288 A) includes an appearance portion extending substantially flush with an engine hood. A groove extending in a vehicle width direction is formed in a portion of the cowl top panel rearward of the appearance portion. A blade of a wiper mechanism is accommodated in the groove.

### SUMMARY

By the way, a layout is conceivable in which the exposed surface of the cowl top garnish is made to extend to the windshield glass in a planar shape as it is, at the same height as the exposed surface of the engine hood. When such a layout is adopted, there is no groove for accommodating the blade of the wiper mechanism. In this case, the blade may be directly subjected to the traveling wind from the front of the vehicle.

The blade includes a wiper rubber that abuts against the windshield glass. When the traveling wind blows against the blade from below the blade, the wiper rubber is disposed so as to block the traveling wind. Depending on the wind power of the traveling wind, the wiper rubber is lifted from the windshield glass. When the wiper rubber is lifted intermittently, the blade flaps and the wiper rubber intermittently hits the windshield glass. As a result, noise is transmitted to the vehicle cabin.

Therefore, the present specification discloses a vehicle front structure capable of suppressing flapping of the blade even when the groove for accommodating the blade of the wiper mechanism is not provided.

The present specification discloses a vehicle front structure. The vehicle front structure includes a windshield glass, an engine hood, a cowl top garnish, and a wiper mechanism. The windshield glass is disposed on a front surface of a vehicle cabin and extends in a vehicle width direction. The engine hood is disposed in front of the windshield glass and covers an engine compartment. The cowl top garnish is disposed between the windshield glass and the engine hood. The wiper mechanism is attached to the cowl top garnish. The wiper mechanism includes a wiper pivot, an arm, and a blade. The wiper pivot protrudes forward of a vehicle from a through hole provided in the cowl top garnish. The arm has one end connected to the wiper pivot and extends in the vehicle width direction. The blade is connected to another end of the arm and extends in the vehicle width direction. Further, the blade includes a wiper rubber that abuts against the windshield glass. The cowl top garnish includes an exposed surface and a rib. The exposed surface includes a front end equal in height to a rear end of an exposed surface of the engine hood and extends in a planar shape from the front end to the windshield glass. The rib is provided in front of the wiper pivot, protrudes from the exposed surface of the cowl top garnish, and extends along the blade in the vehicle width direction.

According to the above configuration, the traveling wind flowing along the engine hood from the front of the vehicle is changed to the upward flow by the rib. As a result, the traveling wind is suppressed from directly blowing against the blade from below the blade.

In the above configuration, the rib may include a rear inclined surface. The rear inclined surface extends obliquely forward from bottom to top and faces the windshield glass. Further, a washer nozzle is attached to the rear inclined surface.

A conventional washer nozzle is disposed in a manner that protrudes from the engine hood and attracts visual attention. Alternatively, by integrating the washer nozzle with the rib, the washer nozzle can be disposed inconspicuously.

In the above configuration, the rib may include a front inclined surface. The front inclined surface extends obliquely rearward from bottom to top. Further, an intersection point between an extension line of the front inclined surface extending from an upper end of the front inclined surface and the windshield glass in a side view of the vehicle is disposed above the blade.

The extension line represents the main trajectory of the traveling wind. By disposing the intersection point between the extension line and the windshield glass above the blade of the wiper mechanism, the traveling wind is suppressed from directly blowing against the blade from below the blade.

According to the vehicle front structure disclosed in the present specification, even when the groove for accommodating the blade of the wiper mechanism is not provided, flapping of the blade can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating an overall view of a vehicle front structure according to the present embodiment;

FIG. 2 is an enlarged perspective view of the right seat side of FIG. 1; and

FIG. 3 is a cross-sectional side view taken along a broken line L0 in FIG. 2.

### DETAILED DESCRIPTION OF EMBODIMENTS

Hereinafter, a vehicle front structure according to the present embodiment will be described with reference to the drawings. The shapes, materials, numbers, and numerical values described below are illustrative examples and can be appropriately changed according to the specifications of the vehicle front structure. In addition, in the following description, the same reference numerals denote the same elements in all the drawings.

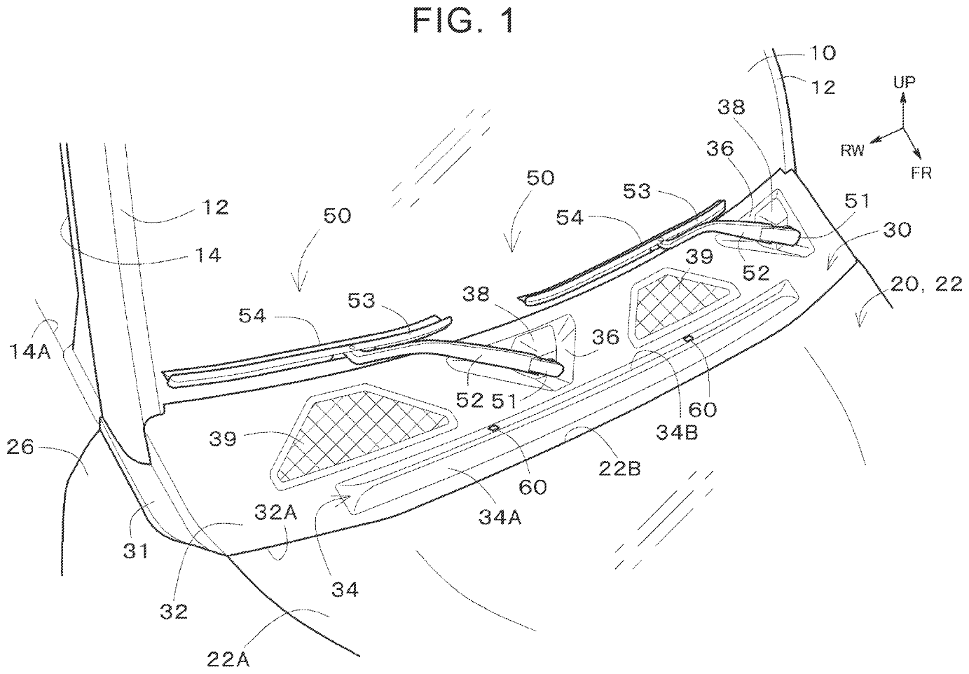

In addition, in FIGS. 1 to 3, an orthogonal coordinate system including a FR axis, a RW axis, and a UP axis is used to represent the positions and orientations of the respective configurations. FR shaft is a vehicle front-rear direction shaft having a vehicle front direction as a positive direction. RW shaft is a vehicle-width-direction shaft having a vehicle-right side as a positive direction. UP shaft is a vehicle-up-down direction shaft whose upward direction is a positive direction.

The vehicle front structure according to the present embodiment is illustrated in FIG. 1. The vehicle front structure includes a windshield glass 10, an engine hood 20, a cowl top garnish 30, and a wiper mechanism 50.

The windshield glass 10 is also referred to as a windshield, and is disposed on the front surface of the vehicle cabin. The windshield glass 10 extends in the vehicle width direction in a posture inclined obliquely rearward from the bottom toward the top.

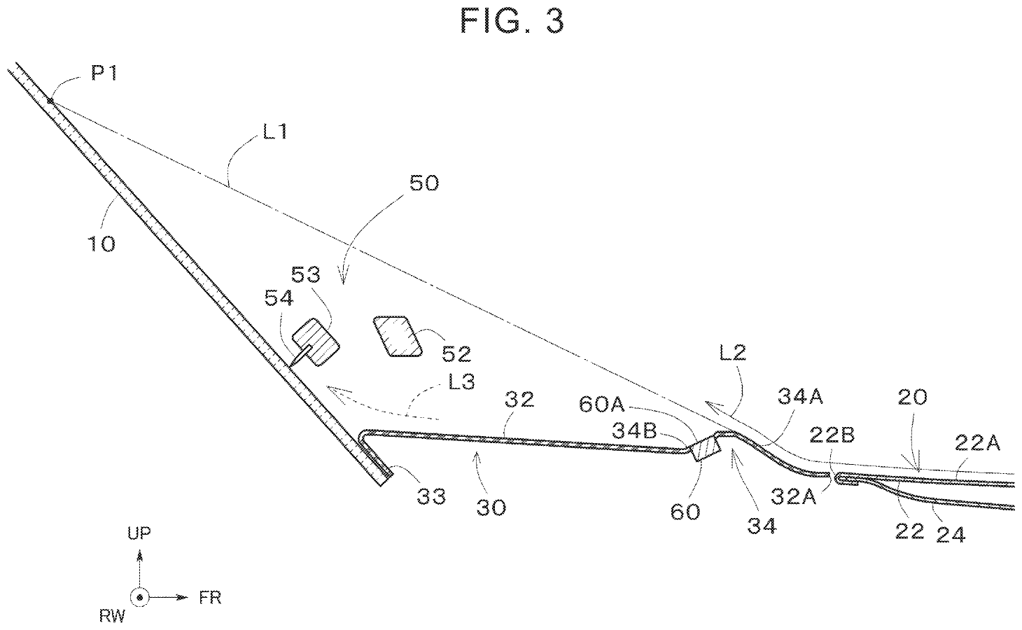

For example, both ends of the windshield glass 10 in the vehicle width direction are supported by a pair of A pillars 12 and 12. Further, referring to FIG. 3, the lower end of the windshield glass 10 is disposed below the exposed surface 32 of the cowl top garnish 30.

The engine hood 20 is disposed in front of the windshield glass 10. The engine hood 20 is a cover part that covers an engine compartment (not shown) provided in front of the vehicle. The engine compartment is an engine compartment in which an internal combustion engine, which is a driving source of a vehicle, is mounted.

When the driving source of the vehicle illustrated in FIG. 1 is a rotary electric machine instead of an internal combustion engine, the engine compartment is precisely called a motor compartment. The engine hood 20 is also referred to as a motor hood. However, in the following description, the engine compartment in which the drive source is mounted is referred to as an engine compartment, and the cover part covering the engine compartment is referred to as an engine hood, regardless of whether the drive source is an internal combustion engine or a rotary electric machine, based on a common designation.

As illustrated in FIG. 1, the engine hood 20 extends in the vehicle width direction, and both ends in the vehicle width direction are adjacent to the upper end of the fender panel 26. For example, the engine hood 20 extends in a planar shape along the vehicle front-rear direction. For example, an arcuate cross-sectional shape in which the vehicle width direction center portion is higher than the vehicle width direction outer portion is extended in the vehicle front-rear direction.

As illustrated in FIG. 3, the engine hood 20 includes a hood outer panel 22, which is an outer plate, and a hood inner panel 24, which is an inner plate. For example, an end portion of the hood outer panel 22 is bent, and an end portion of the hood inner panel 24 is inserted into the bent portion. As illustrated in FIG. 3, the rear end 22B of the engine hood 20 is a folded portion of the hood outer panel 22. The exposed surface 22A of the engine hood 20 is an outer surface of the hood outer panel 22. The exposed surface 22A is a part of 10 the exterior design of the front portion of the vehicle.

As illustrated in FIG. 1, a cowl top garnish 30, which is a decorative part, is disposed between the windshield glass 10 and the engine hood 20. The cowl top garnish 30 is made of, for example, a resin material.

The cowl top garnish 30 includes an exposed surface 32 as a main surface thereof. The exposed surface 32 constitutes a part of the appearance design of the front portion of the vehicle. As illustrated in FIGS. 1 and 3, the position of the cowl top garnish 30 is determined such that the front end 32A of the exposed surface 32 is equal in height to the rear end 22B of the exposed surface 22A of the engine hood 20.

Note that the front end 32A of the exposed surface 32 and the rear end 22B and the height of the exposed surface 22A are equal to each other unless the heights are strictly the same. For example, if there is a difference between the height of the front end 32A of the exposed surface 32 and the height of the rear end 22B of the exposed surface 22A, the height is considered to be (substantially) the same if the difference is within the set assembly tolerances for the cowl top garnish 30 and the engine hood 20.

The cowl top garnish 30 is stretched in plane from the front end 32A to the windshield glass 10. For example, an arcuate cross-sectional shape in which the vehicle width direction center portion is higher than the vehicle width direction outer portion is extended in the vehicle front-rear direction. As further illustrated in FIG. 3, a folded-back portion 33 bent downward is provided at a rear end portion of the cowl top garnish 30. The 30 folded-back portion 33 and the lower end portion of the windshield glass 10 face each other. Further, an adhesive is filled between the folded-back portion 33 and the windshield glass 10.

Since the exposed surface 32 extends to the windshield glass 10 in a planar shape, no groove for accommodating the blade 53 of the wiper mechanism 50 is formed in the cowl top garnish 30. As the groove disappears, the lower space of the cowl top garnish 30 is expanded. In this space, for example, a wiper motor (not shown) and a link mechanism (not shown) are arranged. The link mechanism is connected to the wiper motor and the wiper pivots 51 and 51.

The exposed surface 22A of the engine hood 20 and the exposed surface 32 of the cowl top garnish 30 have a flat, so-called flickering arrangement without forming a substantial step. Note that “no substantial step is formed” means that the difference in height between the exposed surface 22A and the exposed surface 32 falls within the set assembly tolerance for the cowl top garnish 30 and the engine hood 20.

The color scheme of the exposed surface 22A and the exposed surface 32 may be different. If the exposed surface 22A and the exposed surface 32 are the same color, a so-called “long nose” impression can occur for the vehicle front structure. However, such an impression is alleviated by making the color arrangement of the exposed surface 22A and the exposed surface 32 different.

The garnish side 31 is connected to both ends of the cowl top garnish 30 in the vehicle width direction. The garnish side 31 extends around the A-pillar 12 from the outside. The rear end of the garnish side 31 is connected to the window frame lower end 14A of the side door window frame 14. A straight line extending through the lower end 14A of the window frame and extending in the front-rear direction of the vehicle is called a “belt line”. For example, when the garnish side 31 is linearly extended and connected to the window frame lower end 14A, the belt line is connected from the cowl top garnish 30 to the window frame lower end 14A, thereby improving the design.

A rib 34, a depression 36, and a mesh 39 are formed on the exposed surface 32 of the cowl top garnish 30. For example, a pair of meshes 39 is arranged side by side in the vehicle width direction. During rainy weather, rainwater flows from the windshield glass into the mesh 39. A rain gutter (not shown) extends in the vehicle width direction below the mesh 39.

The recess 36 has a shape recessed downward with respect to the exposed surface 32. The same number of recesses 36 as the wiper pivot 51 is formed. For example, a pair of depressions 36, 36 is formed in the exposed surface 32.

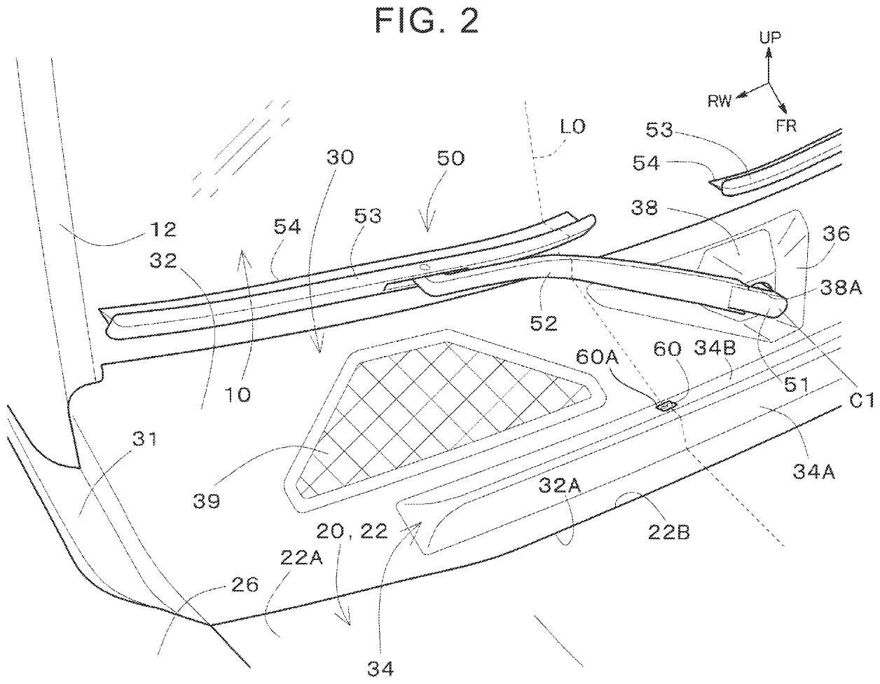

A surface facing the front of the vehicle is formed in the recess 36. On the surface thereof, a protrusion 38 is provided to protrude forward of the vehicle. As illustrated in FIG. 2, a through-hole 38A is drilled in the front end of the protrusion 38. A wiper pivot 51 is inserted into the through-hole 38A.

A wiper mechanism 50 is attached to the cowl top garnish 30. The wiper mechanism 50 includes a wiper pivot 51, an arm 52, and a blade 53. For example, the cowl top garnish 30 is provided with a pair of wiper mechanisms 50 and 50 arranged side by side in the vehicle width direction.

Referring to FIG. 2, the wiper pivot 51 protrudes forward from the through-hole 38A of the cowl top garnish 30. The rotating shaft C1 of the wiper pivot 51 is oriented in the front-rear direction of the vehicle.

The rear end of the wiper pivot 51 is connected to a link mechanism (not shown). The front end of the wiper pivot 51 is connected to the arm 52. One end of the arm 52 is connected to the wiper pivot 51. The other end of the arm 52 is connected to the blade 53. The arm 52 extends in the vehicle width direction while being curved.

The blade 53 is a component extending in the vehicle width direction, and a wiper rubber 54 is attached to a surface facing the windshield glass 10. The distal end of the wiper rubber 54 abuts against the windshield glass 10. For example, an end portion of the arm 52 is connected to a center portion of the blade 53 in the vehicle width direction.

A rib 34 is formed on the exposed surface 32 of the cowl top garnish 30. As illustrated in FIGS. 1 and 2, a rib 34 is formed at a portion forward of the wiper mechanism 50 including the wiper pivot 51.

The rib 34 protrudes upward with respect to the exposed surface 32. As illustrated in FIG. 3, the apex of the rib 34 is defined by the height of the rib 34 so as to be lower than the blade 53. The ribs 34 extend in the vehicle width direction along the pair of blades 53 and 53 arranged in the vehicle width direction. For example, the rib 34 is formed so as to be 60% or more and less than 80% of the total width of the cowl top garnish 30.

As will be described later, the rib 34 has a function of directing the flow of the traveling wind upward and suppressing the amount of traveling air flowing from below the blades 53 and 53. However, the ribs 34 may not extend over the entire width of the pair of blades 53 and 53 arranged in the vehicle width direction. For example, in a range of 80% or more and 100% or less of the total width of the pair of blades 53 and 53, the dimension of the rib 34 in the vehicle width direction is determined.

As illustrated in FIGS. 1 to 3, the ribs 34 comprise a front inclined surface 34A and a rear inclined surface 34B. The front inclined surface 34A is an inclined surface extending obliquely rearward from the bottom toward the top. The rear inclined surface 34B is an inclined surface extending obliquely forward from the bottom to the top.

As illustrated by the arrow L2 in FIG. 3, the traveling wind flowing along the exposed surface 22A of the engine hood 20 changes its trajectory obliquely upward along the front inclined surface 34A. The inclination angle of the front inclined surface 34A is determined so that the changed track is higher than the blade 53. For example, the inclination angle of the front inclined surface 34A is determined such that the extension line L1 of the front inclined surface 34A extending from the upper end of the front inclined surface 34A and the intersection point P1 with the windshield glass 10 are disposed above the blade 53 in a side view of the vehicle. With such an inclination angle setting, the flow of the traveling air passing below the blade 53, such as the arrow L3, is suppressed. As a result, flapping of the blade 53 is suppressed.

The rear inclined surface 34B faces the windshield glass 10. For example, the cowl top garnish 30 does not have a protrusion-like structure that blocks the space between the rear inclined surface 34B and the windshield glass 10.

Based on such a configuration, the washer nozzle 60 is attached to the rear inclined surface 34B of the rib 34. For example, a pair of washer nozzles 60, 60 is attached to the rib 34 corresponding to the pair of blades 53, 53. In FIG. 3, a tube or the like for supplying the washer liquid to the washer nozzle is omitted.

In a conventional vehicle front structure, a washer nozzle is arranged so as to protrude into an engine hood or a cowl top garnish. With such an arrangement, the washer nozzle is a feature that draws attention to appearance. Alternatively, by integrating the washer nozzle 60 with the rib 34, the washer nozzle 60 can be arranged inconspicuously.

In order to dispose the washer nozzle 60 inconspicuously on the rib 34, as illustrated in FIGS. 2 and 3, the inclination angle of the discharge surface 60A of the washer nozzle 60 is determined to be equal to the inclination angle of the rear inclined surface 34B of the rib 34.

For example, the discharge axis of the washer nozzle 60 is determined based on the cleaning area of the windshield glass 10 and the discharge range of the washer nozzle 60. The discharge surface 60A of the washer nozzle 60 and the inclination angle of the rear inclined surface 34B of the ribs 34 are determined so as to be perpendicular to the discharge shaft. Furthermore, a substantial step is not formed between the discharge surface 60A and the rear inclined surface 34B. Both are arranged on the same plane. It should be noted that “no substantial step is formed” means that the positional deviation between the discharge surface 60A and the rear inclined surface 34B falls within the set tolerance to the rib 34 determined with respect to the washer nozzle 60. By adopting such an arrangement, the washer nozzle 60 can be melted in the rib 34 in appearance.

What is claimed is:

1. A vehicle front structure comprising:
a windshield glass disposed on a front surface of a vehicle cabin and extending in a vehicle width direction;
an engine hood disposed in front of the windshield glass and covering an engine compartment;
a cowl top garnish disposed between the windshield glass and the engine hood; and
a wiper mechanism attached to the cowl top garnish, wherein:
the wiper mechanism includes
a wiper pivot protruding forward of a vehicle from a through hole provided in the cowl top garnish,
an arm having one end connected to the wiper pivot and extending in the vehicle width direction, and
a blade connected to another end of the arm and extending in the vehicle width direction, the blade including a wiper rubber that abuts against the windshield glass; and
the cowl top garnish includes
an exposed surface including a front end equal in height to a rear end of an exposed surface of the engine hood and extending in a planar shape from the front end to the windshield glass, and
a rib that is provided in front of the wiper pivot, protrudes from the exposed surface of the cowl top garnish, and extends along the blade in the vehicle width direction.

2. The vehicle front structure according to claim 1, wherein:
the rib is provided with a rear inclined surface extending obliquely forward from bottom to top and facing the windshield glass; and
a washer nozzle is attached to the rear inclined surface.

3. The vehicle front structure according to claim 1, wherein:
the rib includes a front inclined surface extending obliquely rearward from bottom to top; and
an intersection point between an extension line of the front inclined surface extending from an upper end of the front inclined surface and the windshield glass in a side view of the vehicle is disposed above the blade.
